(19) United States
(12) Patent Application Publication
(10) Pub. No.: US 2026/0228097 A1
(43) Pub. Date: Aug. 6, 2026

(54) DEVICE SETTINGS OPTIMIZATION

(71) Applicant: QUALCOMM Incorporated, San Diego, CA (US)

(72) Inventors: Shayan SHAHRAMIAN, Markham (CA); Michael O'FARRELL, Toronto (CA); Yingying FU, Toronto (CA); Paul KUMAR, Toronto (CA)

(21) Appl. No.: 19/531,173

(22) Filed: Feb. 5, 2026

Related U.S. Application Data
(60) Provisional application No. 63/755,154, filed on Feb. 6, 2025.

(51) Int. Cl. G06F 11/22

(52) U.S. Cl. CPC G06F 11/2289

(57) ABSTRACT

A method for optimizing device settings of a plurality of devices includes receiving a performance characteristics target for devices manufactured according to a common design, wherein each device is configurable via device settings and exhibits performance variations over process variations and device operating conditions. The method includes defining a plurality of test cases, each including a combination of a respective device, a process variation, and a device operating condition. The method includes applying a first genetic adaptation algorithm to produce test results, training a neural network to generate predicted performance characteristics, and determining, by using the trained neural network as a surrogate model and applying a second genetic adaptation algorithm, a global set of device settings that collectively achieves the performance characteristics target across the plurality of devices.

### CROSS-REFERENCE TO RELATED APPLICATIONS

This application claims priority to U.S. Application No. 63/755,154, titled MACHINE LEARNING BASED POWER/PERFORMANCE OPTIMIZATION, filed February 6, 2025, which is hereby incorporated by reference for all purposes in its entirety.

### TECHNICAL FIELD OF INVENTION

The present disclosure relates to optimization of configurable electronic devices, and more particularly to machine learning-based methods and systems for determining device settings that achieve performance targets, for example power consumption and performance tradeoffs across multiple devices representing different process variations and operating conditions.

### INTRODUCTION

High-frequency communication integrated circuits, such as serializers and deserializers (SerDes), analog-to-digital converters, digital-to-analog converters, transmitters, and receivers, are configurable through numerous bias settings and configuration options that affect both performance and power consumption. Each circuit within such devices may have recommended default settings derived from analog simulations, but the total number of possible combinations of settings across all circuits can reach into the billions. Because all circuits within a device interact with one another, a setting that produces favorable results for one circuit may adversely affect another circuit, making it impractical to determine optimal combinations through simulation alone.

Manufacturing processes for integrated circuits introduce variations that result in devices falling into different process variations, such as typical-typical, slow-slow, and fast-fast process corners. Additionally, devices operate under varying environmental conditions including different temperatures and signal loss characteristics. These variations mean that a configuration optimized for one particular device under specific conditions may not perform adequately when applied to other devices or under different operating conditions. Genetic adaptation algorithms have been applied to optimize analog circuit configurations, but applying such algorithms to each device individually is time-consuming and may yield different optimal configurations for each device, making it difficult to determine a single configuration that works well across an entire population of devices.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some aspects, a method for optimizing device settings of a plurality of devices includes receiving a performance characteristics target including one or more performance characteristics for the plurality of devices manufactured according to a common design, wherein each of the devices is configurable via a set of device settings and exhibits performance variations over a range of process variations and a range of device operating conditions. The method includes defining a plurality of test cases, each test case including a combination of a respective device of the plurality of devices, a process variation within the range of process variations, and a device operating condition within the range of device operating conditions. The method includes applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data. The method includes training, using the test results, a neural network to generate, for a given set of device settings, predicted performance characteristics. The method includes determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

In some aspects, a system for optimizing device settings of a plurality of devices includes a device measurement system configured to receive a performance characteristics target including one or more performance characteristics for the plurality of devices manufactured according to a common design, wherein each of the devices is configurable via a set of device settings and exhibits performance variations over a range of process variations and a range of device operating conditions. The device measurement system is further configured to define a plurality of test cases, each test case including a combination of a respective device of the plurality of devices, a process variation within the range of process variations, and a device operating condition within the range of device operating conditions, and to apply a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data. The system includes a neural network training system configured to train, using the test results, a neural network to generate, for a given set of device settings, predicted performance characteristics. The system includes a settings generation system configured to determine, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

In some aspects, a non-transitory computer-readable storage medium stores instructions that, when executed by one or more processors, cause the one or more processors to perform operations including receiving a performance characteristics target including one or more performance characteristics for a plurality of devices manufactured according to a common design, wherein each of the devices is configurable via a set of device settings and exhibits performance variations over a range of process variations and a range of device operating conditions. The operations include defining a plurality of test cases, each test case including a combination of a respective device of the plurality of devices, a process variation within the range of process variations, and a device operating condition within the range of device operating conditions. The operations include applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data. The operations include training, using the test results, a neural network to generate, for a given set of device settings, predicted performance characteristics. The operations include determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

Non-limiting and non-exhaustive examples are described with reference to the following figures:

FIG. 1 illustrates a cost function for evaluating power consumption and performance tradeoffs, according to aspects of the present disclosure.

FIG. 2 illustrates a block diagram of a device measurement system, according to aspects of the present disclosure.

FIG. 3 illustrates a block diagram of a neural network training system, according to aspects of the present disclosure.

FIG. 4 illustrates a block diagram of a settings generation system, according to aspects of the present disclosure.

FIG. 5 illustrates a block diagram of a settings verification system, according to aspects of the present disclosure.

FIG. 6 illustrates a block diagram of a device settings optimization system, according to aspects of the present disclosure.

FIG. 7 illustrates a flowchart of a method for optimizing device settings, according to aspects of the present disclosure.

FIG. 8 illustrates a flowchart of a method for optimizing device settings, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Modern electronic devices, such as high-frequency communication devices including serializers/deserializers (SerDes), analog-to-digital converters, digital-to-analog converters, transmitters, and receivers, are configurable via numerous device settings that affect both performance and power consumption. These device settings may include bias settings, configuration options, and other parameters that collectively determine how a device operates. The number of possible combinations of device settings may be extremely large, potentially reaching into the billions, making exhaustive evaluation of all possible combinations impractical.

Devices manufactured according to a common design may exhibit performance variations due to manufacturing process variations. Process variations may include, for example, typical-typical (TT), slow-slow (SS), and fast-fast (FF) corners, among others. Additionally, devices may exhibit performance variations over a range of device operating conditions, such as different temperatures, supply voltages, and signal loss characteristics. A set of device settings that produces acceptable performance for one device for one process variation and one operating condition may not produce acceptable performance for another device for a different process variation or operating condition.

Default device settings provided by analog simulations may be suboptimal because simulations cannot practically evaluate the vast number of possible setting combinations across all relevant process variations and operating conditions. Furthermore, the interactions between different circuits within a device may cause a setting that is beneficial for one circuit to adversely affect another circuit. Finding device settings that achieve a target power consumption and performance tradeoff across multiple devices, process variations, and operating conditions presents a challenging optimization problem.

The disclosed approach addresses this optimization problem through a multi-stage process. In a first stage, a first genetic adaptation algorithm may be applied to test results obtained from a sub-group of devices representing multiple process variations and tested under multiple device operating conditions. The first genetic adaptation algorithm may explore the large search space of possible device settings and identify candidate sets of device settings that satisfy a performance characteristics target for individual test cases. The test results may include the sets of device settings evaluated, measured performance characteristics, and performance-monitoring data that characterizes the state of each device. A variety of different performance characteristics may be evaluated, including, for example, power consumption, bit error rate (BER), signal-to-noise ratio, jitter, latency, throughput, eye diagram parameters, voltage margins, timing margins, and frequency response characteristics. While the examples described herein may depict two performance characteristics being evaluated, namely power consumption and BER, it should be understood that more than two performance characteristics may be used in the optimization process. The cost function may be extended to incorporate additional performance characteristics as needed to achieve a desired multi-dimensional optimization across any number of relevant performance metrics.

In a second stage, a neural network may be trained using the test results to predict performance characteristics for a given set of device settings and performance-monitoring data. The trained neural network may serve as a surrogate model that enables rapid evaluation of potential sets of device settings without requiring time-consuming physical measurements for each setting combination.

In a third stage, a second genetic adaptation algorithm may use the trained neural network as a surrogate model to evaluate potential sets of device settings and determine a global set of device settings. The global set of device settings may be selected to collectively achieve the performance characteristics target across the plurality of devices under the range of process variations and the range of device operating conditions. By averaging or otherwise combining the predicted performance characteristics across multiple devices when evaluating potential sets of device settings, the second genetic adaptation algorithm may identify device settings that work well across the entire population of devices rather than being optimized for any single device.

The disclosed approach may provide several benefits. By testing a sub-group of devices rather than all devices in a batch, and by using a neural network surrogate model to evaluate potential device settings, the approach may reduce the time and resources required to determine device settings that achieve acceptable performance across a population of devices. The size of the sub-group of devices to be tested may be selected to achieve the desired performance characteristics target. In some cases, if a selected sub-group does not produce adequate results, the size of the sub-group may be increased with incremental testing of the newly added devices, and the process for generating the global set of device settings may be repeated using the expanded test results. This iterative approach may allow the optimization process to balance testing efficiency against the need for sufficient device coverage to achieve robust global device settings. The use of genetic adaptation algorithms may enable exploration of the large search space of possible device settings and identification of device settings that achieve a target power consumption and performance tradeoff.

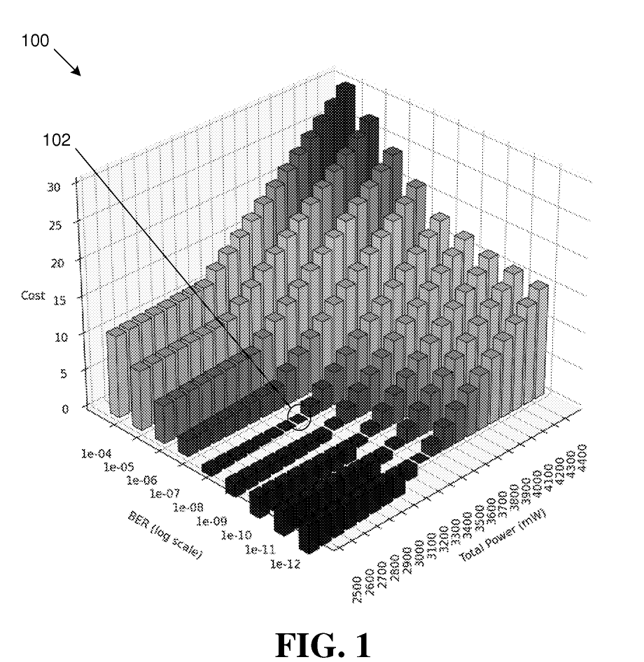

Referring to FIG. 1, the cost function 100 may be used to evaluate power consumption and performance tradeoffs for a plurality of devices manufactured according to a common design. The cost function 100 may receive a performance characteristics target including one or more performance characteristics, such as power consumption and bit error rate (BER). As illustrated in FIG. 1, the cost function 100 may be represented as a three-dimensional surface where one axis represents BER on a logarithmic scale (ranging from 10⁻⁴ to 10⁻¹² in the illustrated example), another axis represents Total Power in milliwatts (ranging from 2500 to 4400mW in the illustrated example), and the vertical axis represents cost values. A target cost 102 may be indicated at a zero-cost level, representing a desired combination of power consumption and performance characteristics. Note that the cost may go below zero. In some cases, this combination of performance characteristics may not be practically realizable. Therefore, the goal is to achieve the lowest cost practically realizable.

With continued reference to FIG. 1, the cost function 100 may include different slopes in different regions based on requirements. In some cases, when neither power consumption nor BER meets the target, the cost function 100 may exhibit steep slopes that produce large cost reductions as either metric improves toward the target. Once power consumption meets the target, the cost function 100 may place more emphasis on improving BER, with the slope in the power direction decreasing while the slope in the BER direction remains steep. Alternatively, once performance meets the target (e.g., BER reaches an acceptable level), the cost function 100 may shift focus to achieving the lowest power consumption, with the slope in the BER direction decreasing while the slope in the power direction remains steep.

In some cases, the slope of the cost function 100 may go to zero in a direction where further improvement regarding a performance characteristic does not bring any further benefit. For example, once BER reaches a sufficiently low level (e.g., 10⁻¹²), further reductions in BER may not provide additional value, and the cost function 100 may exhibit a zero slope in the BER direction at that region. Similarly, once power consumption falls below a target threshold, further power reductions may not provide additional benefit, and the cost function 100 may exhibit a zero slope in the power direction. This behavior of the cost function 100 may allow the optimization process to focus computational resources on improving performance characteristics that provide meaningful benefit rather than pursuing diminishing returns.

The cost function 100 may be used in the further steps described below, including by a device measurement system 200 during a first genetic adaptation process, by a neural network training system 300 during training, and by a settings generation system 400 during a second genetic adaptation process. In each case, the cost function 100 may receive performance characteristics for a device and produce the associated cost. In this example, the performance characteristics includes power consumption and bit error rate.

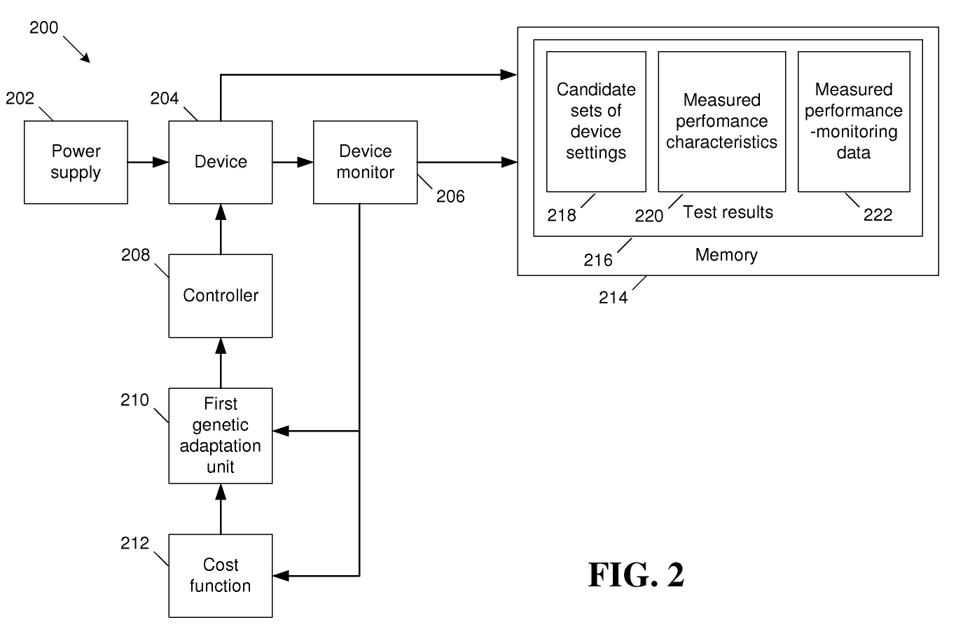

Referring to FIG. 2, the device measurement system 200 may be used to apply a first genetic adaptation algorithm to a plurality of test cases to determine, for each test case, a candidate set of device settings that satisfies the performance characteristics target and to produce test results. The device measurement system 200 may include a power supply 202, a device 204, a device monitor 206, a controller 208, a first genetic adaptation unit 210, a cost function 212, and a memory 214. The power supply 202 may be coupled to the device 204 and may provide electrical power to the device 204. The device 204 may be configurable via a set of device settings and may exhibit performance variations over a range of process variations and a range of device operating conditions.

With continued reference to FIG. 2, the device 204 may include one or more of a serializer/deserializer (SerDes), an analog-to-digital converter, a digital-to-analog converter, a transmitter, and a receiver. In some cases, the device 204 may include a SerDes platform with multiple bias settings that affect performance and power of the chip. The bias settings may include various configuration options that collectively determine how the device 204 operates, and the number of possible combinations of bias settings may be extremely large.

The device monitor 206 may be coupled to the device 204 and may monitor and measure performance characteristics of the device 204. The device monitor 206 may provide data to the memory 214, including measured performance characteristics. The device monitor 206 may also record performance-monitoring (PMON) data for each part during genetic algorithm runs. The PMON data may characterize the state of the device 204 and may be used as input features for training a neural network in subsequent stages of the optimization process.

The first genetic adaptation unit 210 may implement a genetic adaptation algorithm that operates through iterative evolution of candidate solutions. The genetic adaptation algorithm may maintain a population of candidate sets of device settings, where each candidate represents a potential configuration for the device 204. In each generation, the genetic adaptation algorithm may evaluate each candidate set of device settings by configuring the device 204 with the candidate settings, measuring the resulting performance characteristics using the device monitor 206, and computing a cost value using the cost function 212. Candidates with lower cost values may be considered more fit and may have a higher probability of being selected for reproduction in subsequent generations.

The genetic adaptation algorithm may apply genetic operators to generate new candidate sets of device settings from the selected candidates. Crossover operations may combine portions of two parent candidate sets to produce offspring candidates that inherit characteristics from both parents. Mutation operations may introduce random variations to candidate sets, which may help the algorithm explore new regions of the search space and avoid convergence to local optima. The balance between crossover and mutation may be adjusted through algorithm parameters to control the exploration and exploitation behavior of the optimization process.

The input to the genetic adaptation algorithm may include an initial population of candidate sets of device settings, which may be generated randomly or seeded with default settings from analog simulations. The input may also include algorithm parameters such as population size, number of generations, crossover probability, and mutation rate. The output of the genetic adaptation algorithm may include a candidate set of device settings that achieves a low cost value according to the cost function 212, along with the test results comprising all evaluated sets of device settings, the measured performance characteristics produced by each set, and the measured performance-monitoring data recorded during evaluation. The test results may be stored in the memory 214 for use in subsequent stages of the optimization process.

As further shown in FIG. 2, the memory 214 may store test results 216. The test results 216 may include candidate sets of device settings 218, measured performance characteristics 220, and measured performance-monitoring data 222. The candidate sets of device settings 218 may include the sets of device settings evaluated by the first genetic adaptation algorithm. The measured performance characteristics 220 may include power consumption and bit error rate measurements produced by the sets of device settings. The measured performance-monitoring data 222 may include PMON data recorded for each part during the genetic algorithm runs. The measured performance-monitoring data 222 may also include environmental information, such as temperature, and information regarding a process variation associated with each device.

The controller 208 may be coupled to the device 204 and may configure the device 204 according to device settings received from the first genetic adaptation unit 210. The first genetic adaptation unit 210 may be a processing circuit configured to execute a first genetic adaptation algorithm. The first genetic adaptation unit 210 may receive input from the cost function 212 and may output device settings to the controller 208. The cost function 212 may receive inputs from the device monitor 206, including the measured performance characteristics 220 produced when the device 204 is configured with device settings generated by the first genetic adaptation unit 210. Based on these inputs, the cost function 212 may produce a resulting cost function value that indicates how well the current device settings achieve the target power consumption and performance tradeoff. The first genetic adaptation unit 210 may use the cost function value to evaluate and optimize device settings.

A plurality of test cases may be defined, where each test case includes a combination of a respective device of the plurality of devices, a process variation within the range of process variations, and a device operating condition within the range of device operating conditions. The range of process variations may include at least two of a typical-typical process corner, a slow-slow process corner, and a fast-fast process corner. In some cases, the test cases may include testing across multiple losses using coupon traces with different losses on the boards, allowing multiple losses and lanes to be tested at the same time. The device operating conditions may include different temperatures, supply voltages, and signal loss characteristics.

With continued reference to FIG. 2, the first genetic adaptation unit 210 may apply the first genetic adaptation algorithm to each of the plurality of test cases to determine, for each test case, a candidate set of device settings that satisfies the performance characteristics target and to produce the test results 216. The test results 216 may include all of the sets of device settings evaluated by the first genetic adaptation algorithm, the measured performance characteristics 220 produced by the sets of device settings, and the measured performance-monitoring data 222.

In some cases, the test results 216 may include repeated test results obtained for each device of the plurality of devices using the same set of device settings. The first genetic adaptation algorithm may include repeat runs settings at the cost of longer measured time to address repeatability issues caused by run-to-run variations with power on reset that can have one order of spread on BER. By performing multiple measurements for the same device setting, the first genetic adaptation unit 210 may reduce noise in the cost function evaluation and may avoid suboptimal solutions caused by measurement variability.

The first genetic adaptation unit 210 may include a settings cache such that if the same setting is tried multiple times, the cached value may be used to help reduce runtime. The number of occurrences before using the cache may be programmable, which may help alleviate repeatability issues while also improving runtime efficiency. The settings cache may store previously evaluated device settings along with the corresponding measured performance characteristics, allowing the first genetic adaptation unit 210 to retrieve cached results rather than performing redundant measurements.

The genetic algorithm runs may take approximately 5 hours per part, making the genetic algorithm runs impractical to run on each part in the field. This runtime constraint motivates the use of a neural network surrogate model in subsequent stages of the optimization process, as described further below. By training a neural network using the test results 216 obtained from a sub-group of devices, the optimization process may evaluate potential sets of device settings without requiring time-consuming physical measurements for each setting combination on each device.

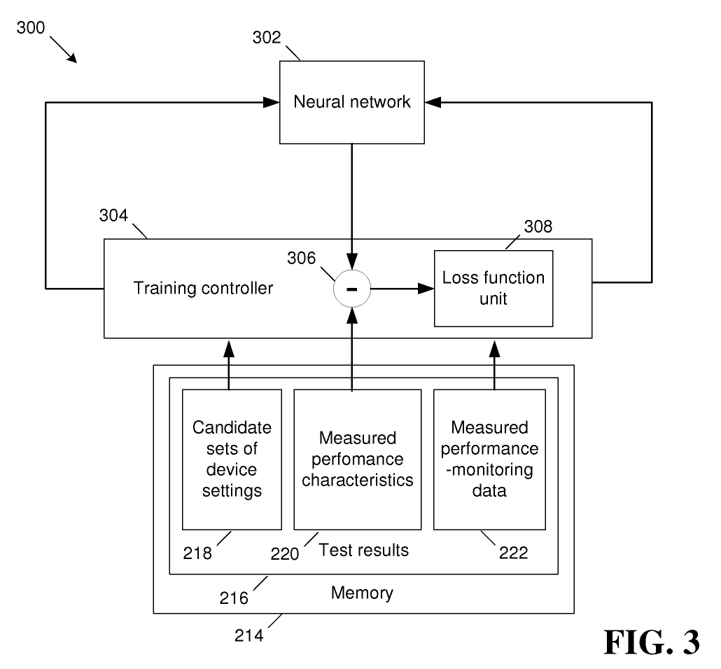

Referring to FIG. 3, a neural network training system 300 may be used to train, using the test results 216, a neural network 302 to generate, for a given set of device settings, predicted performance characteristics. The neural network training system 300 may include the neural network 302, a training controller 304, a subtractor 306, a loss function unit 308, and the memory 214. The memory 214 may store the test results 216, which include the candidate sets of device settings 218, the measured performance characteristics 220, and the measured performance-monitoring data 222 obtained from the device measurement system 200 as described above.

With continued reference to FIG. 3, the neural network 302 may receive inputs from the memory 214, including the candidate sets of device settings 218 and the measured performance-monitoring data 222 from the test results 216. Based on these inputs, the neural network 302 may generate and output predicted performance characteristics. The predicted performance characteristics may include predicted power consumption and predicted bit error rate values corresponding to the input device settings and performance-monitoring data. The neural network 302 may learn to map the relationship between device settings, performance-monitoring data, and resulting performance characteristics through the training process.

As further shown in FIG. 3, the subtractor 306 may receive the predicted performance characteristics from the neural network 302 and the measured performance characteristics 220 from the memory 214. The subtractor 306 may compute a difference between the predicted performance characteristics and the measured performance characteristics 220. This difference may represent the prediction error of the neural network 302 for a given set of device settings and performance-monitoring data.

The loss function unit 308 may receive the difference from the subtractor 306 and may compute a loss value based on the difference. The loss value may quantify how accurately the neural network 302 predicts the measured performance characteristics 220. The training controller 304 may receive the loss value from the loss function unit 308 and may adjust parameters of the neural network 302 to minimize the loss. The training controller 304 may use backpropagation or other training techniques to update the weights and biases of the neural network 302 based on the computed loss value.

With continued reference to FIG. 3, the training controller 304 may interface with the memory 214 to retrieve the test results 216 for use during the training process. Through iterative training, the neural network 302 may learn to generate predicted performance characteristics that closely match the measured performance characteristics 220 for the candidate sets of device settings 218 stored in the memory 214. The training process may continue until the neural network 302 achieves a desired level of prediction accuracy or until a convergence criterion is satisfied.

The neural network 302 may be trained using loss and environmental conditions such as temperature as additional training features along with bias settings and performance-monitoring data to help model accuracy. By including temperature as a training feature, the neural network 302 may learn how device performance varies across different operating temperatures. By including loss as a training feature, the neural network 302 may learn how device performance varies across different signal loss conditions, such as those encountered with different trace lengths or channel characteristics. The inclusion of these or other additional training features may enable the neural network 302 to generate more accurate predicted performance characteristics across the range of device operating conditions.

Once trained, the neural network 302 may serve as a surrogate model that enables rapid evaluation of potential sets of device settings without requiring time-consuming physical measurements for each setting combination. The trained neural network 302 may be used by the settings generation system 400 to evaluate potential sets of device settings that were not included in the test results 216 obtained during the first genetic adaptation process. This capability may allow the optimization process to explore a larger portion of the device settings search space than would be practical using physical measurements alone.

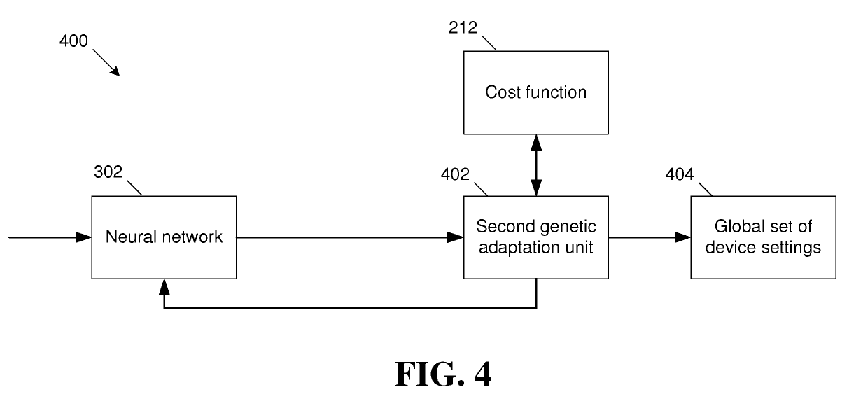

Referring to FIG. 4, a settings generation system 400 may be used to determine a global set of device settings 404. The settings generation system 400 may use the trained neural network 302 as a surrogate model of the measured performance characteristics 220, enabling rapid evaluation of potential device configurations without requiring time-consuming physical measurements. The settings generation system 400 may apply a second genetic adaptation algorithm to evaluate potential sets of device settings using the trained neural network 302. The global set of device settings 404, when applied to the plurality of devices, may collectively achieve the performance characteristics target across the plurality of devices under the range of process variations and the range of device operating conditions. The settings generation system 400 may include the neural network 302, a second genetic adaptation unit 402, the cost function 212, and the global set of device settings 404.

With continued reference to FIG. 4, the neural network 302 may receive performance-monitoring data as input, where the performance-monitoring data characterizes the state of each device and may include information regarding process variations, temperature, and other environmental conditions. The neural network 302 may also receive potential sets of device settings from the second genetic adaptation unit 402 as input. Based on these inputs, the neural network 302 may generate predicted performance characteristics, including predicted power consumption and predicted bit error rate values, and provide them to the second genetic adaptation unit 402.

As further shown in FIG. 4, the second genetic adaptation unit 402 may be a processing circuit configured to execute a second genetic adaptation algorithm. The second genetic adaptation unit 402 may generate potential sets of device settings that are provided to the neural network 302 and receive predicted performance characteristics in return, resulting in a feedback loop that enables iterative evaluation. The second genetic adaptation unit 402 may send predicted performance characteristics to the cost function 212 and receive a cost value back, where the cost value indicates how well the potential sets of device settings achieve the target power consumption and performance tradeoff. The cost function 212 may be the same cost function 100 described with reference to FIG. 1, providing consistent evaluation criteria throughout the optimization process.

With continued reference to FIG. 4, evaluating the potential sets of device settings using the trained neural network 302 may include applying a potential set of device settings to the trained neural network 302 for each device of the plurality of devices to produce a plurality of predicted performance characteristics. For each device, the neural network 302 may receive the potential set of device settings along with the performance-monitoring data specific to that device, enabling device-specific predictions that account for process variations and operating conditions. The plurality of predicted performance characteristics may then be combined into combined predicted performance characteristics and provided to the second genetic adaptation algorithm. In some cases, the second genetic adaptation algorithm may use an average cost across all parts when evaluating candidate sets of device settings to find settings that work well across temperature, losses, and process variations. By averaging the predicted performance characteristics across multiple devices, the second genetic adaptation unit 402 may identify device settings that achieve acceptable performance for the entire population of devices rather than being optimized for any single device. Other methods may also be used to combine the predicted performance characteristics, e.g., weighted average, median value, worst-case analysis, or percentile-based metrics.

The neural network 302 may allow bias settings to be tried that do not exist in the genetic data set from the first genetic adaptation algorithm, enabling exploration beyond the tested settings. Because the neural network 302 has learned the relationship between device settings, performance-monitoring data, and resulting performance characteristics, the neural network 302 may generate predicted performance characteristics for device settings that were not evaluated during the first genetic adaptation process. This interpolation and extrapolation capability may allow the second genetic adaptation unit 402 to explore a larger portion of the device settings search space than would be practical using physical measurements alone. The second genetic adaptation unit 402 may iterate through multiple generations of potential device settings, where each generation includes a population of candidate device settings. For each candidate set, the second genetic adaptation unit 402 may provide the candidate set to the neural network 302 along with performance-monitoring data for each device, receive predicted performance characteristics, and evaluate them using the cost function 212 to obtain a cost value. Based on the cost values, the second genetic adaptation unit 402 may select higher-performing candidate sets of device settings for reproduction, apply genetic operations such as crossover and mutation to generate a new population of candidate device settings, and repeat the evaluation process. Because the neural network 302 provides rapid predictions compared to physical measurements, the second genetic adaptation unit 402 may evaluate significantly more candidate device settings per unit time than would be possible using the device measurement system 200. This iterative process may continue until the second genetic adaptation unit 402 identifies a global set of device settings 404 that achieves the desired cost value across the plurality of devices under the range of process variations and device operating conditions, or until a convergence criterion or maximum number of generations is reached.

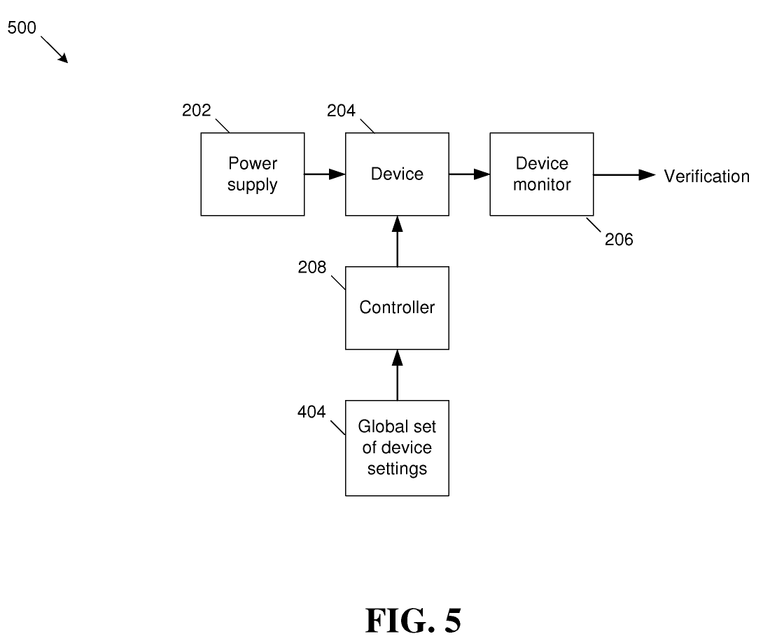

With continued reference to FIG. 4, the second genetic adaptation unit 402 may output the global set of device settings 404, which represents device settings that, when applied to a plurality of devices, collectively achieve the performance characteristics target across the plurality of devices under a range of process variations and a range of device operating conditions. The global set of device settings 404 may be a single configuration that provides robust performance across the entire device population, eliminating the need for device-specific tuning. The settings generation system 400 may enable rapid evaluation of potential sets of device settings by using the neural network 302 as a surrogate model, allowing the second genetic adaptation unit 402 to explore device settings that may not have been included in the test results 216 obtained during the first genetic adaptation process. The global set of device settings 404 may subsequently be verified using the settings verification system 500 described with reference to FIG. 5.

Referring to FIG. 5, the settings verification system 500 may be used to apply the global set of device settings 404 to each device of the plurality of devices to verify that each device achieves the performance characteristics target. The settings verification system 500 may include the power supply 202, the device 204, the device monitor 206, the controller 208, and the global set of device settings 404. The power supply 202 may be coupled to the device 204 and may provide electrical power to the device 204 during verification testing.

With continued reference to FIG. 5, the controller 208 may be coupled to the device 204 and may receive input from the global set of device settings 404. The controller 208 may configure the device 204 according to the global set of device settings 404. By applying the global set of device settings 404 to the device 204, the controller 208 may set the device 204 to operate with the device settings determined by the settings generation system 400 to collectively achieve the performance characteristics target across the plurality of devices under the range of process variations and the range of device operating conditions.

As further shown in FIG. 5, the device monitor 206 may be coupled to the device 204 and may monitor the device 204 when the device 204 is configured with the global set of device settings 404. The device monitor 206 may measure performance characteristics of the device 204, including power consumption and bit error rate (or other performance characteristic), to verify that the device 204 achieves the performance characteristics target. The device monitor 206 may compare the measured performance characteristics with the performance characteristics target to verify that the performance characteristics target is met and may output a verification indication based on the comparison.

The settings verification system 500 may enable testing of the global set of device settings 404 on each device of the plurality of devices to verify that each device achieves the performance characteristics target when configured with the global set of device settings 404. In some cases, the verification process may be performed on all devices in a batch or on a representative sample of devices from the batch. The verification process may confirm that the global set of device settings 404 determined by the settings generation system 400 produces acceptable performance across the plurality of devices under the range of process variations and the range of device operating conditions.

In some cases, the verification process may identify devices that do not achieve the performance characteristics target when configured with the global set of device settings 404. In some cases, if all of the plurality of devices do not meet the performance characteristics target when configured with the global set of device settings 404, some or all of the optimization steps may be repeated to identify a better global set of device settings. For example, additional test cases may be defined and evaluated using the first genetic adaptation algorithm to produce additional test results, the neural network 302 may be retrained using the additional test results to improve prediction accuracy, and the second genetic adaptation algorithm may be applied again using the retrained neural network 302 to determine an improved global set of device settings. In some aspects, the cost function 100 may be adjusted to place greater emphasis on performance characteristics that were not adequately achieved during the initial optimization process. The iterative refinement process may continue until a global set of device settings is identified that enables all of the plurality of devices to achieve the performance characteristics target, or until a predetermined number of iterations has been performed.

In another approach, devices that fail verification may be flagged for further analysis, may be assigned to a different bin with alternative device settings, or may be rejected from the batch. The verification process may also provide feedback regarding the accuracy of the neural network 302 used as a surrogate model during the settings generation process. If the measured performance characteristics obtained during verification differ from the predicted performance characteristics generated by the neural network 302, the neural network 302 may be retrained or refined using the additional measurement data.

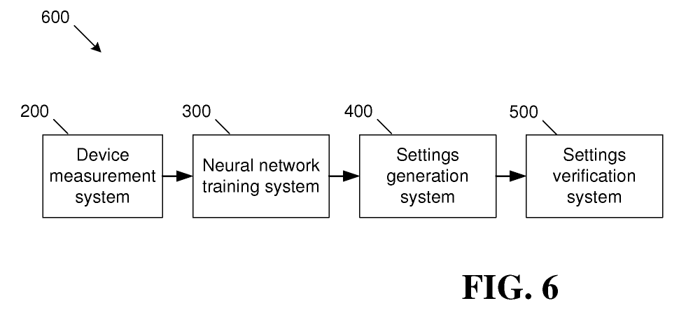

Referring to FIG. 6, a device settings optimization system 600 may coordinate the interaction of the device measurement system 200, the neural network training system 300, the settings generation system 400, and the settings verification system 500 to perform a complete optimization workflow for determining device settings that achieve a performance characteristics target across a plurality of devices.

The device measurement system 200 may be coupled to the neural network training system 300. The neural network training system 300 may be coupled to the settings generation system 400. The settings generation system 400 may be coupled to the settings verification system 500. This arrangement may enable a sequential flow of data and processing through the optimization workflow, where each system receives inputs from a preceding system and provides outputs to a subsequent system.

With continued reference to FIG. 6, the optimization workflow may begin with the device measurement system 200 defining a plurality of test cases. Each test case may include a combination of a respective device of the plurality of devices, a process variation within the range of process variations, and a device operating condition within the range of device operating conditions. The device measurement system 200 may then apply the first genetic adaptation algorithm to each of the plurality of test cases to determine, for each test case, a candidate set of device settings that satisfies the performance characteristics target. The device measurement system 200 may produce test results including the sets of device settings evaluated by the first genetic adaptation algorithm, the measured performance characteristics produced by the sets of device settings, and performance-monitoring data. The device measurement system 200 may provide the test results to the neural network training system 300.

As further shown in FIG. 6, the neural network training system 300 may receive the test results from the device measurement system 200. The neural network training system 300 may train a neural network using the test results to generate predicted performance characteristics for a given set of device settings and performance-monitoring data. Through iterative training, the neural network may learn to map the relationship between device settings, performance-monitoring data, and resulting performance characteristics. Once training is complete, the neural network training system 300 may provide the trained neural network to the settings generation system 400.

With continued reference to FIG. 6, the settings generation system 400 may receive the trained neural network from the neural network training system 300. The settings generation system 400 may use the trained neural network as a surrogate model that enables rapid evaluation of potential sets of device settings without requiring time-consuming physical measurements. The settings generation system 400 may apply a second genetic adaptation algorithm to evaluate potential sets of device settings using the trained neural network. For each potential set of device settings, the settings generation system 400 may provide the potential set to the trained neural network along with performance-monitoring data for each device of the plurality of devices, receive predicted performance characteristics from the trained neural network, and evaluate the predicted performance characteristics to determine how well the potential set of device settings achieves the performance characteristics target across the plurality of devices. Based on this evaluation, the settings generation system 400 may determine a global set of device settings that, when applied to the plurality of devices, collectively achieves the performance characteristics target across the plurality of devices under the range of process variations and the range of device operating conditions. The settings generation system 400 may provide the global set of device settings to the settings verification system 500.

The settings verification system 500 may receive the global set of device settings from the settings generation system 400. The settings verification system 500 may apply the global set of device settings to each device of the plurality of devices to verify that each device achieves the performance characteristics target. The settings verification system 500 may configure each device according to the global set of device settings and may measure performance characteristics of each device to confirm that the global set of device settings produces acceptable performance across the plurality of devices under the range of process variations and the range of device operating conditions.

Certain components may be shared among multiple systems within the device settings optimization system 600. The memory 214 may be a part of both the device measurement system 200 and the neural network training system 300, enabling the test results produced by the device measurement system 200 to be accessed by the neural network training system 300 for training the neural network. The neural network 302 may be a part of both the neural network training system 300 and the settings generation system 400, where the neural network training system 300 trains the neural network 302 and the settings generation system 400 uses the trained neural network 302 as a surrogate model. The cost function 212 may be a part of both the device measurement system 200 and the settings generation system 400, providing consistent evaluation criteria for both the first genetic adaptation algorithm and the second genetic adaptation algorithm. The power supply 202, the device monitor 206, and the controller 208 may be parts of both the device measurement system 200 and the settings verification system 500, enabling these components to be used for both initial testing during the first genetic adaptation process and for verification testing of the global set of device settings.

This sharing of components among multiple systems may reduce hardware duplication and may enable efficient use of resources throughout the optimization workflow. The shared components may maintain consistent measurement and control capabilities across different stages of the optimization process, which may help ensure that the performance characteristics measured during verification correspond to the performance characteristics measured during the initial testing used to train the neural network.

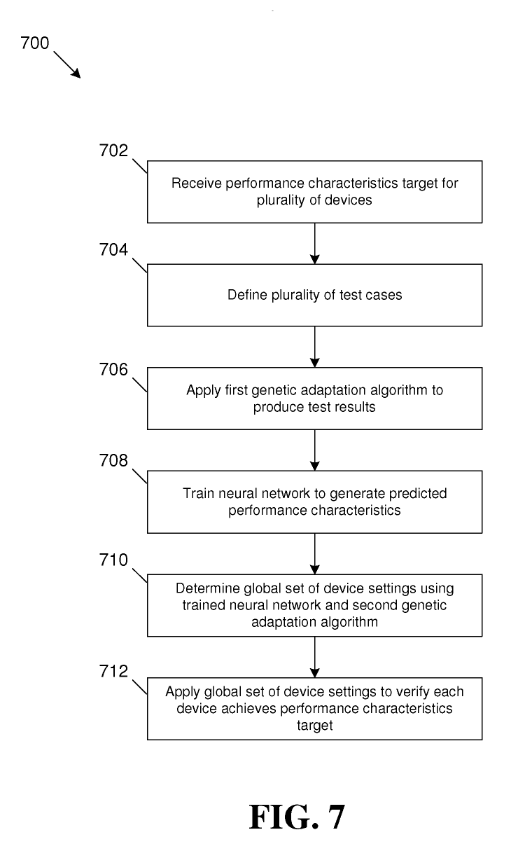

Referring to FIG. 7, a method 700 for optimizing device settings of a plurality of devices may be performed by the device settings optimization system 600 or by individual components thereof. The method 700 may enable determination of a global set of device settings that achieves a performance characteristics target across a plurality of devices manufactured according to a common design, where each device is configurable via a set of device settings and exhibits performance variations over a range of process variations and a range of device operating conditions.

At step 702, the method 700 may include receiving a performance characteristics target including one or more performance characteristics for the plurality of devices manufactured according to a common design. The performance characteristics target may specify desired values or ranges for performance metrics such as power consumption and bit error rate. Each of the devices may be configurable via a set of device settings and may exhibit performance variations over a range of process variations and a range of device operating conditions. The performance characteristics target may be received by the device measurement system 200 and may be used to configure the cost function 212 for evaluating device settings throughout the optimization process.

At step 704, the method 700 may include defining a plurality of test cases. Each test case may include a combination of a respective device of the plurality of devices, a process variation within the range of process variations, and a device operating condition within the range of device operating conditions. The test cases may be selected to provide coverage across different process variations, such as typical-typical, slow-slow, and fast-fast corners, and across different device operating conditions, such as different temperatures and signal loss characteristics. The plurality of test cases may be defined to capture the variability in device performance that may be encountered across the population of devices.

At step 706, the method 700 may include applying a first genetic adaptation algorithm to each of the plurality of test cases to determine, for each test case, a candidate set of device settings that satisfies the performance characteristics target and to produce test results. The test results may include the sets of device settings evaluated by the first genetic adaptation algorithm, the measured performance characteristics produced by the sets of device settings, and performance-monitoring data. The first genetic adaptation algorithm may explore the search space of possible device settings and may identify candidate sets of device settings that achieve acceptable performance for individual test cases.

At step 708, the method 700 may include training, using the test results, a neural network to generate, for a given set of device settings, predicted performance characteristics. The neural network may be trained using the candidate sets of device settings, the measured performance characteristics, and the performance-monitoring data from the test results. Through the training process, the neural network may learn to predict performance characteristics for device settings and performance-monitoring data combinations, including combinations that were not directly evaluated during the first genetic adaptation process.

At step 710, the method 700 may include determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions. The second genetic adaptation algorithm may use the trained neural network to rapidly evaluate potential sets of device settings across multiple devices without requiring time-consuming physical measurements. By combining predicted performance characteristics across the plurality of devices, the second genetic adaptation algorithm may identify device settings that achieve acceptable performance for the entire population of devices.

At step 712, the method 700 may include applying the global set of device settings to each device of the plurality of devices to verify that each device achieves the performance characteristics target. The verification step may confirm that the global set of device settings determined using the neural network surrogate model produces acceptable performance when applied to actual devices. The verification may be performed using the settings verification system 500, which may configure each device according to the global set of device settings and measure performance characteristics to confirm that the performance characteristics target is achieved.

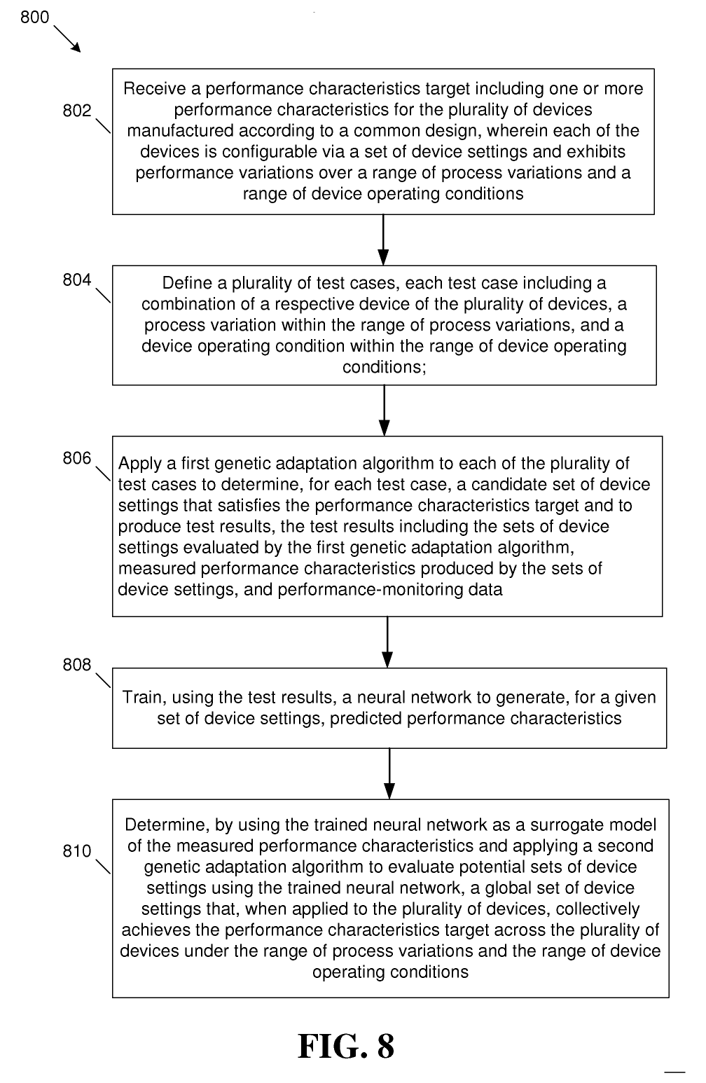

Referring to FIG. 8, a method 800 for optimizing device settings of a plurality of devices may be performed by the device settings optimization system 600 or by individual components thereof. The method 800 may provide an alternative representation of the optimization workflow for determining a global set of device settings that achieves a performance characteristics target across a plurality of devices manufactured according to a common design.

At step 802, the method 800 may include receiving a performance characteristics target including one or more performance characteristics for the plurality of devices manufactured according to a common design, wherein each of the devices is configurable via a set of device settings and exhibits performance variations over a range of process variations and a range of device operating conditions. The performance characteristics target may define the desired tradeoff between power consumption and performance metrics such as bit error rate.

At step 804, the method 800 may include defining a plurality of test cases, each test case including a combination of a respective device of the plurality of devices, a process variation within the range of process variations, and a device operating condition within the range of device operating conditions. The test cases may be selected to provide representative coverage of the variability expected across the device population.

At step 806, the method 800 may include applying a first genetic adaptation algorithm to each of the plurality of test cases to determine, for each test case, a candidate set of device settings that satisfies the performance characteristics target and to produce test results. The test results may include the sets of device settings evaluated by the first genetic adaptation algorithm, measured performance characteristics produced by the sets of device settings, and performance-monitoring data.

At step 808, the method 800 may include training a neural network using the test results to generate, for a given set of device settings, predicted performance characteristics. The neural network may learn the relationship between device settings, performance-monitoring data, and resulting performance characteristics through the training process.

At step 810, the method 800 may include determining a global set of device settings by using the trained neural network as a surrogate model of the measured performance characteristics and applying a second genetic adaptation algorithm to evaluate potential sets of device settings using the trained neural network. The global set of device settings, when applied to the plurality of devices, may collectively achieve the performance characteristics target across the plurality of devices under the range of process variations and the range of device operating conditions.

Artificial intelligence (AI) and machine learning (ML) functionality may be utilized in the operations described herein. AI generally refers to methods and software that enable machines to perceive their environment and use learning and intelligence to take actions that maximize their chances of achieving defined goals, such as making predictions, recommendations, or decisions. ML is a subset of AI concerned with statistical algorithms that can learn from data and generalize to unseen data, thereby performing tasks without explicit instructions. The AI/ML techniques referenced herein may include any type of AI and/or ML related processes, algorithms, or methods utilized to achieve the described functions. In other aspects, techniques that are not AI and/or ML related may be utilized to achieve the described functions.

The functions described herein may be implemented using any suitable processor, including ML-type processors for compute-intensive tasks involved in training and running ML models and deep learning algorithms. Suitable processors include Central Processing Units (CPUs), Graphics Processing Units (GPUs), Tensor Processing Units (TPUs), Field-Programmable Gate Arrays (FPGAs), Neural Processing Units (NPUs), Application-Specific Integrated Circuits (ASICs), Digital Signal Processors (DSPs), general purpose microprocessors, controllers, microcontrollers, state machines, discrete gate or transistor logic, discrete hardware components, or any combination thereof designed to perform the functions described herein. A processor may also be implemented as a combination of computing devices, such as a combination of a DSP and a microprocessor, a plurality of microprocessors, or one or more microprocessors in conjunction with a DSP core.

Various illustrative logical blocks, modules, circuits, and algorithm steps described in connection with the aspects disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limitations.

Various modifications to the described aspects may be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. Depending on the example, certain acts or events of any of the techniques described herein can be performed in a different sequence, may be added, merged, or left out altogether. Moreover, in certain examples, acts or events may be performed concurrently through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another according to a communication protocol. In this manner, computer-readable media generally may correspond to (1) tangible computer-readable storage media which is non-transitory or (2) a communication medium such as a signal or carrier wave. A computer program product may include a computer-readable medium. A non-transitory computer-readable storage medium may store instructions that, when executed by one or more processors, cause the one or more processors to perform operations of the various methods described herein. By way of example, and not limitation, computer-readable storage media can comprise RAM, ROM, EEPROM, CD-ROM or other optical disk storage, magnetic disk storage or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies are included in the definition of medium. However, computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of interoperative hardware units, including one or more processors as described above, in conjunction with suitable software and/or firmware. In addition, in some aspects, the functionality described herein may be provided within dedicated hardware and/or software modules or incorporated in a combined implementation. The techniques could also be fully implemented in one or more circuits or logic elements.

One or more of the components, steps, features and/or functions illustrated in FIGS. 1-7 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware. For example, instructions may be stored in memory, as previously described.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Various examples have been described. These and other examples are within the scope of the following claims.

Aspect 1: A method for optimizing device settings of a plurality of devices, the method may include: receiving a performance characteristics target including one or more performance characteristics for the plurality of devices manufactured according to a common design, where each of the devices is configurable via a set of device settings and exhibits performance variations over a range of process variations and a range of device operating conditions; defining a plurality of test cases, each test case including a combination of a respective device of the plurality of devices, a process variation within the range of process variations, and a device operating condition within the range of device operating conditions; applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data; training, using the test results, a neural network to generate, for a given set of device settings, predicted performance characteristics; and determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

Aspect 2: The method according to aspect 1, where the determining includes providing the trained neural network with performance-monitoring data regarding the devices and the potential sets of device settings.

Aspect 3: The method according to either of aspect 1 or 2, where the determining includes outputting, from the trained neural network to the second genetic adaptation algorithm, the predicted performance characteristics for the devices.

Aspect 4: The method according to any of aspects 1-3, further may include applying the global set of device settings to each device of the plurality of devices to verify that each device achieves the performance characteristics target.

Aspect 5: The method as any of aspects 1-4, where the devices include one or more of a serializer/deserializer, an analog-to-digital converter, a digital-to-analog converter, a transmitter, and a receiver.

Aspect 6: The method as any of aspects 1-5, where the performance characteristics target includes power consumption and bit error rate.

Aspect 7: The method as any of aspects 1-6, where the test results include repeated test results obtained for each device of the plurality of devices using a same set of device settings.

Aspect 8: The method as any of aspects 1-7, where evaluating the potential sets of device settings using the trained neural network further includes: applying a potential set of device settings to the trained neural network for each device of the plurality of devices to produce a plurality of predicted performance characteristics; combining the plurality of predicted performance characteristics into combined predicted performance characteristics; and providing the combined predicted performance characteristics to the second genetic adaptation algorithm.

Aspect 9: The method as any of aspects 1-8, where the range of process variations includes a typical-typical process corner, a slow-slow process corner, and a fast-fast process corner.

Aspect 10: A system for optimizing device settings of a plurality of devices, the system may include: a device measurement system configured to receive a performance characteristics target including one or more performance characteristics for the plurality of devices manufactured according to a common design, where each of the devices is configurable via a set of device settings and exhibits performance variations over a range of process variations and a range of device operating conditions, the device measurement system further configured to define a plurality of test cases, each test case including a combination of a respective device of the plurality of devices, a process variation within the range of process variations, and a device operating condition within the range of device operating conditions, and to apply a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data; a neural network training system configured to train, using the test results, a neural network to generate, for a given set of device settings, predicted performance characteristics; and a settings generation system configured to determine, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

Aspect 11: The system according to aspect 10, where the settings generation system is configured to provide the trained neural network with performance-monitoring data regarding the devices and the potential sets of device settings.

Aspect 12: The system according to either of aspect 10 or 11, where the trained neural network is configured to output, to the second genetic adaptation algorithm, the predicted performance characteristics for the devices.

Aspect 13: The system according to any of aspects 10-12, further may include a settings verification system configured to apply the global set of device settings to each device of the plurality of devices to verify that each device achieves the performance characteristics target.

Aspect 14: The system as any of aspects 10-13, where the devices include one or more of a serializer/deserializer, an analog-to-digital converter, a digital-to-analog converter, a transmitter, and a receiver.

Aspect 15: The system as any of aspects 10-14, where the settings generation system is configured to evaluate the potential sets of device settings using the trained neural network by: applying a potential set of device settings to the trained neural network for each device of the plurality of devices to produce a plurality of predicted performance characteristics; combining the plurality of predicted performance characteristics into combined predicted performance characteristics; and providing the combined predicted performance characteristics to the second genetic adaptation algorithm.

Aspect 16: A non-transitory computer-readable storage medium storing instructions that, when executed by one or more processors, cause the one or more processors to perform operations may include: receiving a performance characteristics target including one or more performance characteristics for a plurality of devices manufactured according to a common design, where each of the devices is configurable via a set of device settings and exhibits performance variations over a range of process variations and a range of device operating conditions; defining a plurality of test cases, each test case including a combination of a respective device of the plurality of devices, a process variation within the range of process variations, and a device operating condition within the range of device operating conditions; applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data; training, using the test results, a neural network to generate, for a given set of device settings, predicted performance characteristics; and determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

Aspect 17: The non-transitory computer-readable storage medium as aspect 16, where the determining includes providing the trained neural network with performance-monitoring data regarding the devices and the potential sets of device settings.

Aspect 18: The non-transitory computer-readable storage medium as either of aspect 16 or 17, where the determining includes outputting, from the trained neural network to the second genetic adaptation algorithm, the predicted performance characteristics for the devices.

Aspect 19: The non-transitory computer-readable storage medium as any of aspects 16-18, where the operations further may include applying the global set of device settings to each device of the plurality of devices to verify that each device achieves the performance characteristics target.

Aspect 20: The non-transitory computer-readable storage medium as any of aspects 16-19, where evaluating the potential sets of device settings using the trained neural network further includes: applying a potential set of device settings to the trained neural network for each device of the plurality of devices to produce a plurality of predicted performance characteristics; combining the plurality of predicted performance characteristics into combined predicted performance characteristics; and providing the combined predicted performance characteristics to the second genetic adaptation algorithm.

1. A method for optimizing device settings of a plurality of devices, the method comprising:
receiving a performance characteristics target including one or more performance characteristics for the plurality of devices manufactured according to a common design, wherein each of the devices is configurable via a set of device settings and exhibits performance variations over a range of process variations and a range of device operating conditions;
defining a plurality of test cases, each test case including a combination of a respective device of the plurality of devices, a process variation within the range of process variations, and a device operating condition within the range of device operating conditions;
applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data;
training, using the test results, a neural network to generate, for a given set of device settings, predicted performance characteristics; and
determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

2. The method according to claim 1, wherein the determining includes providing the trained neural network with performance-monitoring data regarding the devices and the potential sets of device settings.

3. The method according to claim 2, wherein the determining includes outputting, from the trained neural network to the second genetic adaptation algorithm, the predicted performance characteristics for the devices.

4. The method according to claim 1, further comprising applying the global set of device settings to each device of the plurality of devices to verify that each device achieves the performance characteristics target.

5. The method of claim 1, wherein the devices include one or more of a serializer/deserializer, an analog-to-digital converter, a digital-to-analog converter, a transmitter, and a receiver.

6. The method of claim 1, wherein the performance characteristics target includes power consumption and bit error rate.

7. The method of claim 1, wherein the test results include repeated test results obtained for each device of the plurality of devices using a same set of device settings.

8. The method of claim 1, wherein evaluating the potential sets of device settings using the trained neural network further includes:
applying a potential set of device settings to the trained neural network for each device of the plurality of devices to produce a plurality of predicted performance characteristics;
combining the plurality of predicted performance characteristics into combined predicted performance characteristics; and
providing the combined predicted performance characteristics to the second genetic adaptation algorithm.

9. The method of claim 1, wherein the range of process variations includes a typical-typical process corner, a slow-slow process corner, and a fast-fast process corner.

10. A system for optimizing device settings of a plurality of devices, the system comprising:
a device measurement system configured to receive a performance characteristics target including one or more performance characteristics for the plurality of devices manufactured according to a common design, wherein each of the devices is configurable via a set of device settings and exhibits performance variations over a range of process variations and a range of device operating conditions, the device measurement system further configured to define a plurality of test cases, each test case including a combination of a respective device of the plurality of devices, a process variation within the range of process variations, and a device operating condition within the range of device operating conditions, and to apply a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data;
a neural network training system configured to train, using the test results, a neural network to generate, for a given set of device settings, predicted performance characteristics; and
a settings generation system configured to determine, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

11. The system according to claim 10, wherein the settings generation system is configured to provide the trained neural network with performance-monitoring data regarding the devices and the potential sets of device settings.

12. The system according to claim 11, wherein the trained neural network is configured to output, to the second genetic adaptation algorithm, the predicted performance characteristics for the devices.

13. The system according to claim 10, further comprising a settings verification system configured to apply the global set of device settings to each device of the plurality of devices to verify that each device achieves the performance characteristics target.

14. The system of claim 10, wherein the devices include one or more of a serializer/deserializer, an analog-to-digital converter, a digital-to-analog converter, a transmitter, and a receiver.

15. The system of claim 10, wherein the settings generation system is configured to evaluate the potential sets of device settings using the trained neural network by:
applying a potential set of device settings to the trained neural network for each device of the plurality of devices to produce a plurality of predicted performance characteristics;
combining the plurality of predicted performance characteristics into combined predicted performance characteristics; and
providing the combined predicted performance characteristics to the second genetic adaptation algorithm.

16. A non-transitory computer-readable storage medium storing instructions that, when executed by one or more processors, cause the one or more processors to perform operations comprising:
receiving a performance characteristics target including one or more performance characteristics for a plurality of devices manufactured according to a common design, wherein each of the devices is configurable via a set of device settings and exhibits performance variations over a range of process variations and a range of device operating conditions;
defining a plurality of test cases, each test case including a combination of a respective device of the plurality of devices, a process variation within the range of process variations, and a device operating condition within the range of device operating conditions;
applying a first genetic adaptation algorithm to each of the plurality of test cases to determine, for each test case, a candidate set of device settings that satisfies the performance characteristics target and to produce test results, the test results including the sets of device settings evaluated by the first genetic adaptation algorithm, measured performance characteristics produced by the sets of device settings, and performance-monitoring data;
training, using the test results, a neural network to generate, for a given set of device settings, predicted performance characteristics; and
determining, by using the trained neural network as a surrogate model of the measured performance characteristics and applying a second genetic adaptation algorithm to evaluate potential sets of device settings using the trained neural network, a global set of device settings that, when applied to the plurality of devices, collectively achieves the performance characteristics target across the plurality of devices under the range of process variations and the range of device operating conditions.

17. The non-transitory computer-readable storage medium of claim 16, wherein the determining includes providing the trained neural network with performance-monitoring data regarding the devices and the potential sets of device settings.

18. The non-transitory computer-readable storage medium of claim 17, wherein the determining includes outputting, from the trained neural network to the second genetic adaptation algorithm, the predicted performance characteristics for the devices.

19. The non-transitory computer-readable storage medium of claim 16, wherein the operations further comprise applying the global set of device settings to each device of the plurality of devices to verify that each device achieves the performance characteristics target.

20. The non-transitory computer-readable storage medium of claim 16, wherein evaluating the potential sets of device settings using the trained neural network further includes:
applying a potential set of device settings to the trained neural network for each device of the plurality of devices to produce a plurality of predicted performance characteristics;
combining the plurality of predicted performance characteristics into combined predicted performance characteristics; and
providing the combined predicted performance characteristics to the second genetic adaptation algorithm.
